(19) United States
(12) Patent Application Publication
(10) Pub. No.: US 2017/0369119 A1
(43) Pub. Date: Dec. 28, 2017

(54) Motorcycle Absolute Ride-Height Controller

(71) Applicant: Randall Wayne Ashdown, Esparto, CA (US)

(72) Inventor: Randall Wayne Ashdown, Esparto, CA (US)

(21) Appl. No.: 15/192,899

(22) Filed: Jun. 24, 2016

(51) Int. Cl. B62K 25/28; B62K 25/08; B62K 25/04

(52) U.S. Cl. CPC B62K 25/28; B62K 25/08; B62K 2201/08; B62K 2025/044; B62K 2207/00; B62K 2025/045

(57) ABSTRACT

A ride-height robust sensor measures shock absorber travel and monitors absolute ride-height in a front and rear shock absorber of a motorcycle regardless of varying cargo weights. Rather than modifying the frame, the sensor is mountable directly to a motorcycle rear shock absorber using a novel upper mount and lower mount. A second sensor is mountable to a front shock absorber using a novel ride-height upper fork bracket and ride-height lower fork bracket. A novel ride-height display module and attendant control module provide a visual display of shock height using a multicolored six LED array. User-customised ride-height and dismount height are activated upon motor ignition and cutoff using a solenoid control module. Components are electronically isolated from the motorcycle ignition system and shock solenoids for accuracy and reliability. The ride-height controller enters sleep mode when not in use and is installable by the user.

### FIELD OF THE INVENTION

The present invention relates generally to aftermarket motorcycle parts. More particularly, the present invention relates to monitoring and control apparatus for motorcycle suspensions that uses shock-absorber length for monitoring and solenoid controllers for setting user-programmable ride-height.

### BACKGROUND INFORMATION

It is an object of the present invention to provide a new and improved technique to determine and control the ride-height of a motor cycle. Setting a motorcycle suspension height using a single, unmonitored shock-absorber setting can lead to wildly varying ride-heights and unexpectedly scraping and jarring the frame. Further, some motorcycle ride-heights, especially on touring bikes, are too high for comfortable dismounting. Measuring the suspension height using pressure gauges becomes inaccurate if the cargo, fuel level or number of riders is changed. Accurate measuring of ride-heights in varying conditions therefore requires a direct measurement of shock length.

A rheostat arm or wheel mounted to the motorcycle frame can be set to measure shock absorber travel, but this method results in both poor accuracy and poor resolution when mounted to a working motorcycle. A more elegant method of providing motorcycle ride-height monitoring and control is sought.

### SUMMARY

A linear transducer acts as a robust and accurate installable sensor for measuring shock absorber travel and monitoring ride-height in a front and rear shock absorber of a motorcycle. The robust ride-height sensor used is capable of measuring shock absorber travel of as little as 2.5 inches for a Softail or up to 4.75 inches for a custom touring bike.

However, installable motorcycle modifications of this type are typically mounted to the frame, which would require an unmanageably large sensor in this case. For example, a linear transducer mounted to the frame and swing arm would require an awkward and expensive frame modification and 14-inch transducer.

Instead, in the invention, a small ride-height robust sensor is mountable directly to a rear shock absorber using a novel upper mount and lower mount. A second ride-height robust sensor is mountable to a front shock absorber using a novel ride-height upper fork bracket and ride-height lower fork bracket.

A ride-height display module and attendant control module connected to the front and rear ride-height robust sensors provides a visual display of absolute shock lengths ranging from shock absorber maximum travel, minimum travel and graduated travel lengths in between. The ride-height display module is calibrated to custom motorcycle frames upon installation by matching display maximum and minimum with shock travel maximum and minimum. A multicolored six LED display helps the rider determine ride-height at a glance, day or night.

The ride-height display module is also used to input a custom Auto Air-Up setting to customize the suspension ride-height and a custom Auto Dump setting to customize the suspension dismount height. The motorcycle absolute ride-height controller will thereafter activate solenoid-controlled shock-absorbers to raise the motorcycle suspension to Auto Air-Up height upon ignition start and lower the suspension to Auto Dump height upon ignition cutoff. Ride-height and dismount height activation can also be controlled by rider button inputs, or disabled when not wanted.

The ride-height controller, display module and sensors are protected from the signal noise and voltage spikes of a motorcycle electrical system by isolation circuitry. Solenoid output circuitry is capable of providing up to 4 amps in solenoid control. The control module microprocessor is fast enough to process and display shock travel in real time over every road bump and features a sleep mode when not in use.

Other methods and structures are described in the detailed description below. This summary does not purport to define the invention. The invention is defined by the claims.

### BRIEF DESCRIPTION OF THE DRAWINGS

FIG. 1 is a side view of rear mounted portion of the motorcycle absolute ride-height controller in the preferred embodiment of the invention.

FIG. 2 shows a side view of a ride-height robust sensor.

FIG. 3 shows an overhead view of a ride-height upper mount.

FIG. 4 shows a cross-section view of a strap side of a ride-height upper mount.

FIG. 5 is a flattened viewed of the ride-height lower mount.

FIG. 6 is an exploded view of the ride-height lower mount folded into shape.

FIG. 7 is a side view of front mounted portion of the motorcycle absolute ride-height controller in the preferred embodiment of the invention.

FIG. 8 is a flattened viewed of the ride-height upper fork bracket.

FIG. 9 is a flattened viewed of the ride-height robust sensor clamp.

FIG. 10 is a view of the ride-height robust sensor clamp folded into shape.

FIG. 11 is a perspective view of the ride-height lower fork bracket.

FIG. 12 is a side view of the ride-height lower fork bracket.

FIG. 13 depicts an exemplary front side of the ride-height display module.

FIG. 14 depicts an exemplary back side of the ride-height display module.

FIG. 15 is a simplified flowchart showing connections between components of the motorcycle absolute ride-height controller in the preferred embodiment of the invention.

### DETAILED DESCRIPTION

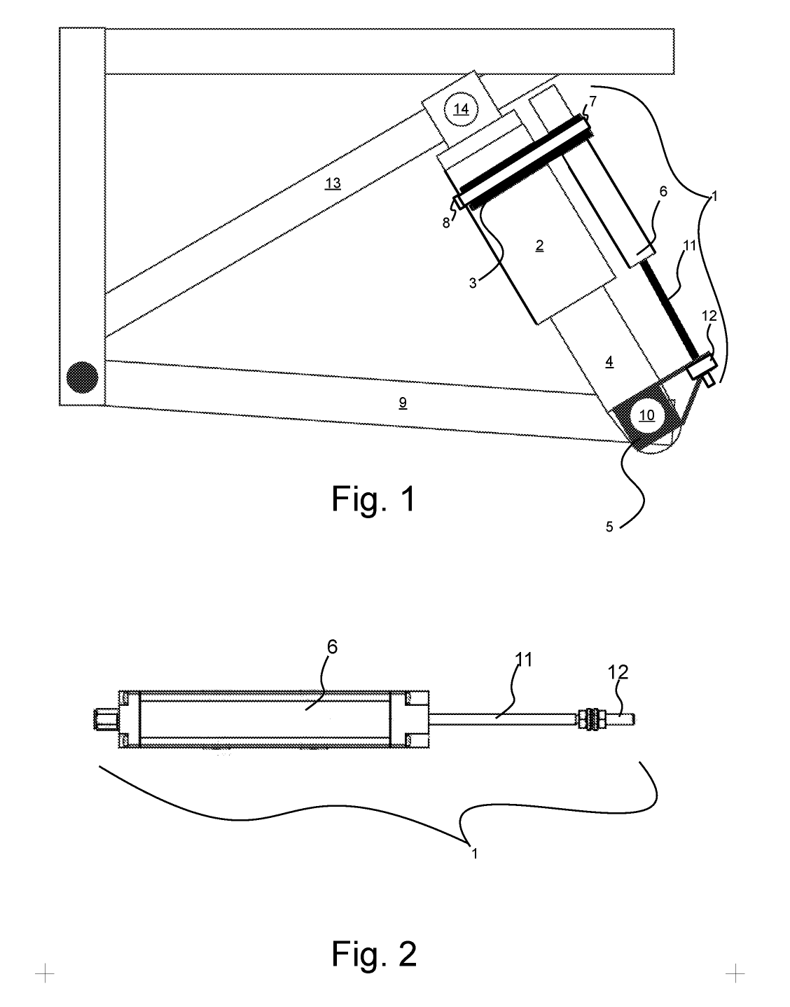

FIG. 1 is a side view of rear mounted portion of the motorcycle absolute ride-height controller in the preferred embodiment of the invention, including a ride-height robust sensor, ride-height upper mount and ride-height lower mount.

The rear mounted portion of the motorcycle absolute ride-height controller is mounted to the rear suspension of a motorcycle. The ride-height robust sensor 1 is mounted to the sheath or upper portion 2 of a motorcycle shock absorber using the ride-height upper mount 3. The ride-height robust sensor 1 is mounted to the stem or lower portion 4 of a motorcycle shock absorber using the ride-height lower mount 5.

The ride-height upper mount 3 is shaped to fit a portion of the circumference of the shock absorber sheath 2 on one side and the ride-height robust sensor body 6 on the other. A securing strap 7 is wrapped around the outside of the ride-height upper mount 3, securing ride-height robust sensor body 6 securely to rear shock sheath 2. In the preferred embodiment, the securing strap 7 is a hose clamp with a securing screw 8.

The ride-height lower mount 5 is a bracket shaped with a horizontal hole through which it is attached to the motorcycle swing-arm 9 with a swing-arm bolt 10. In most cases, this will mean it is bolted to a swing-arm linkage. The ride-height lower mount 5 is also shaped with a vertical hole through which it is secured to the extensible rod portion 11 of the ride-height robust sensor 1 by the ride-height robust sensor's rod bolt 12.

In the figure, a typical single-shock swing arm is indicated. The shock is mounted diagonally and therefore the vertical hole of the ride-height lower mount 5 is diagonally vertical. The top end of the shock is typically secured to an upper rear portion of the motorcycle frame 13 with an upper rear shock bolt 14. For a twinshock motorcycle, it is only necessary to mount the ride-height robust sensor to one of the rear shocks.

FIG. 2 shows a side view of a ride-height robust sensor. The ride-height robust sensor 1 is a linear sensor capable of measuring shock absorber lengths of up 4.75 inches and as low as 2.5 inches. The ride-height robust sensor 1 must be capable of delivering accurate shock length measurements repeatedly despite being subjected to the noise and vibration of an operating motorcycle.

In the preferred embodiment of the invention, the ride-height robust sensor is a linear transducer or linear potentiometer operating as a voltage divider. The extension of the extensible rod portion 11 from the body portion 6 of the ride-height robust sensor 1 corresponds directly to the extension of the shock absorber stem, the ride-height robust sensor therefore producing a ride-height signal directly corresponding to the height of the shock absorber. An elastic strain gauge works similarly, but is not expected to be as durable as a linear transducer. A pressure gauge is not used as a ride-height robust sensor in the invention because different rider and cargo weights give inaccurate measures of ride-height. Similarly, a rheostat arm or wheel used to measure the shock absorber stem travel tends to be inaccurate and to give poor resolution.

In the described embodiment, a 125 millimeter linear displacement transducer is used. The ride-height robust sensor body 6 as shown has a rectangular cross-section, though some embodiments will use a sensor with a rounded body.

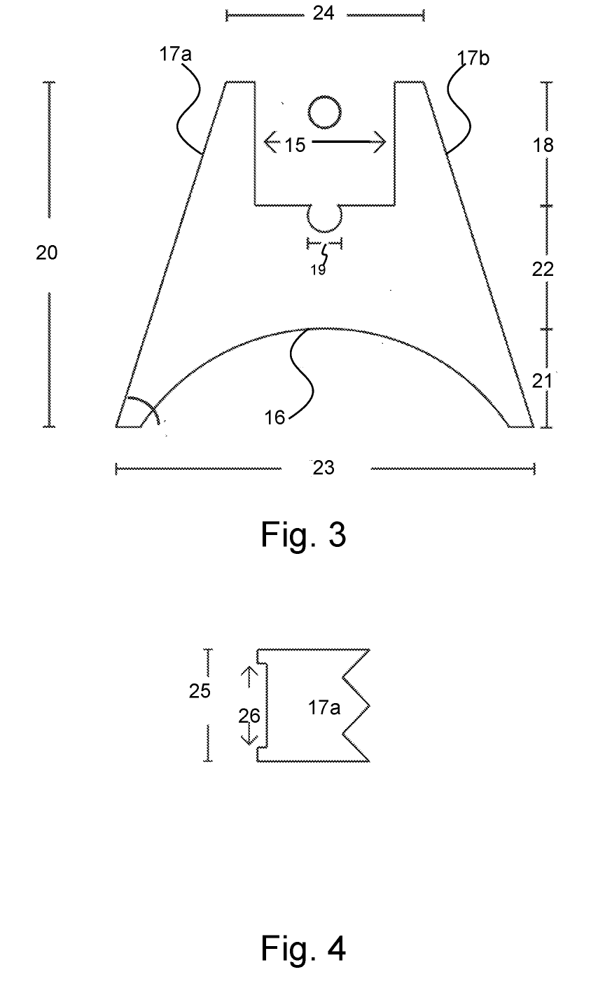

FIG. 3 shows an overhead view of a ride-height upper mount 3. The ride-height upper mount 3 comprises a ride-height robust sensor body opening 15, a shock absorber body opening 16 connected by strap sides 17a and 17b. In the described embodiment, the ride-height robust sensor body opening 15 is rectangular with a width of eighteen millimeters, a rectangular depth 18 of 0.625 inches and screw opening 19 on the inner edge 0.171 inches in diameter 19. In the described embodiment, the front to back depth 20 of the ride-height upper mount 3 is 1.75 inches, with the strap sides 17a and 17b sloped to minimized bends in the securing strap of FIG. 1, above.

In the described embodiment, the shock absorber body opening 16 has a radius of 2.250 inches, a depth 21 of 0.50 inches and is separated from the ride-height robust sensor body opening 15 by 0.625 inches of HDPE plastic 22. The plastic body of the ride-height upper mount 3 is wider than the shock absorber body opening 16 and the ride-height robust sensor body opening 15 at their respective edges for strength. In the described embodiment, shock absorber edge 23 is 2.125 inches wide and the sensor body edge 24 is one inch wide.

FIG. 4 shows a cross-section view of a strap side 17a of a ride-height upper mount. The strap side depth 25 is sufficient to provide strength to the ride-height upper mount and to leave room for an interior strap channel 26. In the preferred embodiment, the strap side depth 25 is 0.750 inches of HDPE plastic with a 0.562 inch wide interior strap channel 26. The interior strap channel 26 prevents the securing strap from slipping upward or downward off of the ride-height upper mount.

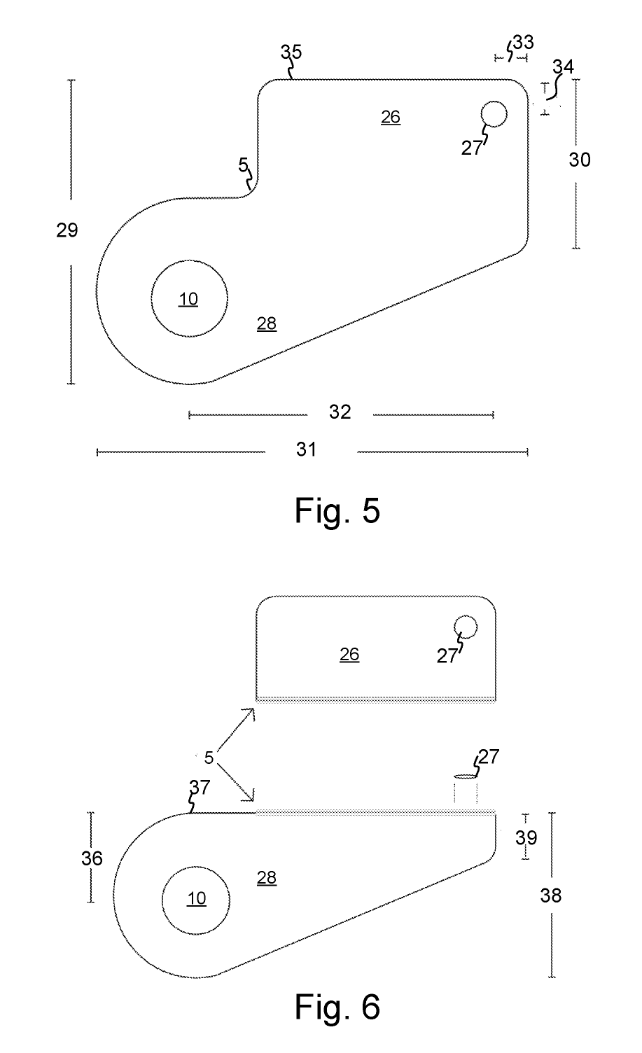

FIG. 5 is a flattened viewed of the ride-height lower mount 5. The ride-height lower mount 5 comprises a limb surface 26 with a vertical screw hole 27 and a side surface 28 with a horizontal screw hole 10. The ride-height lower mount 5 is of steel or other material of sufficient rigidity when folded to hold a ride-height robust sensor to the shock absorber of a moving motorcycle.

Measurements are indicated for the preferred embodiment of the ride-height lower mount 5: 0.250 inches on the wide unfolded side 36 and 1.250 inches on the narrow unfolded side 30. The lengthwise edge 31 is 3.187 inches in the preferred embodiment with 2.250 inches separation 32 between the screw holes. The vertical screw hole 27 is 0.250 inches separation 33 from the narrow unfolded side 30 and 0.250 inches separation 34 from the limb surface edge 35.

FIG. 6 is an exploded view of the ride-height lower mount 5 folded into shape. Limb surface 26 is folded perpendicular to side surface 28. In the preferred embodiment, ride-height lower mount horizontal screw hole 10 is offset 36 from the fold edge 37 by 0.750 inches, the side surface edge 38 measures 1.375 inches and the narrow portion of the side surface below the fold 39 measures 0.375 inches.

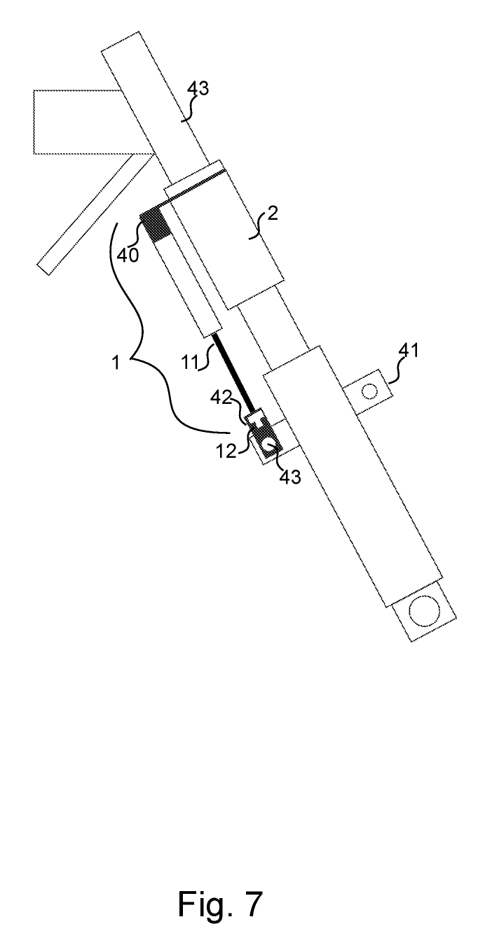

FIG. 7 is a side view of front mounted portion of the motorcycle absolute ride-height controller in the preferred embodiment of the invention, including a ride-height robust sensor, ride-height upper fork bracket and ride-height lower fork bracket.

The front mounted portion of the motorcycle absolute ride-height controller is mounted to the front fork of a motorcycle. The ride-height robust sensor 1 is mounted to the sheath or upper portion 2 of a motorcycle shock absorber using the ride-height upper fork bracket 40. The ride-height robust sensor 1 is mounted to the lower portion 41 of the front fork using the ride-height lower fork bracket 42.

The ride-height upper fork bracket 40 is shaped to be held, on both sides of the twin fork, between the upper portion 43 of the front fork and the sheath portion 2 of the motorcycle shock absorber. Measuring the front ride-height requires measuring only one front shock, so the ride-height upper fork bracket 40 holds a ride-height robust sensor 1 on only one side.

The ride-height lower fork bracket 42 is shaped with a horizontal hole through which it is attached to the lower portion 41 of the front fork with a lower fork bolt 43. The ride-height lower fork bracket 42 is also shaped with a vertical hole through which it is secured to the extensible rod portion 11 of the ride-height robust sensor 1 by the ride-height robust sensor's rod bolt 12. In the figure, a typical front twin-fork is indicated. The shock is mounted diagonally and therefore the vertical hole of the ride-height lower fork bracket 42 is diagonally vertical.

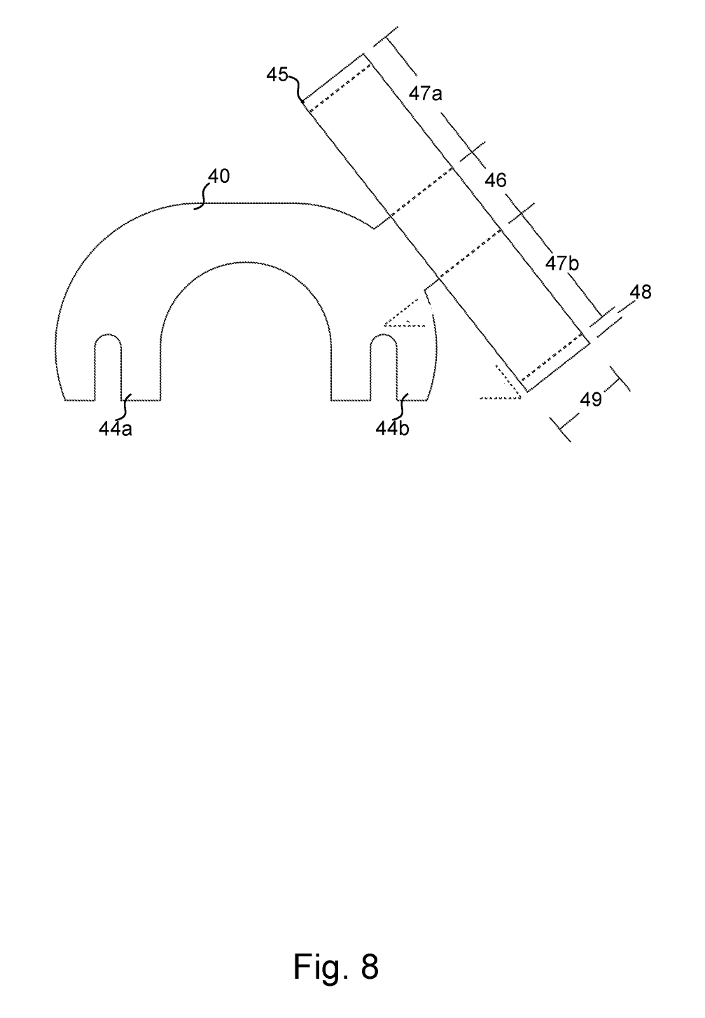

FIG. 8 is a flattened viewed of the ride-height upper fork bracket 40. Right slat 44a and left slat 44b fit the right and left sides of the motorcycle front fork. The upper fork sensor clamp 45 comprises a middle portion 46 and side fold sections 47a and 47b. In the preferred embodiment, the ends of the side fold sections comprise underfold sections 48 to clip onto the ride-height robust sensor.

In the preferred embodiment, upper fork sensor clamp middle portion 46 is 0.75 inches in length and side fold sections 47a and 47b are 1.25 inches each, with the underfold sections 48 extending a further 0.125 inches from the ends of the side fold sections. In the preferred embodiment, the upper fork sensor clamp 45 section width 49 is 0.75 inches.

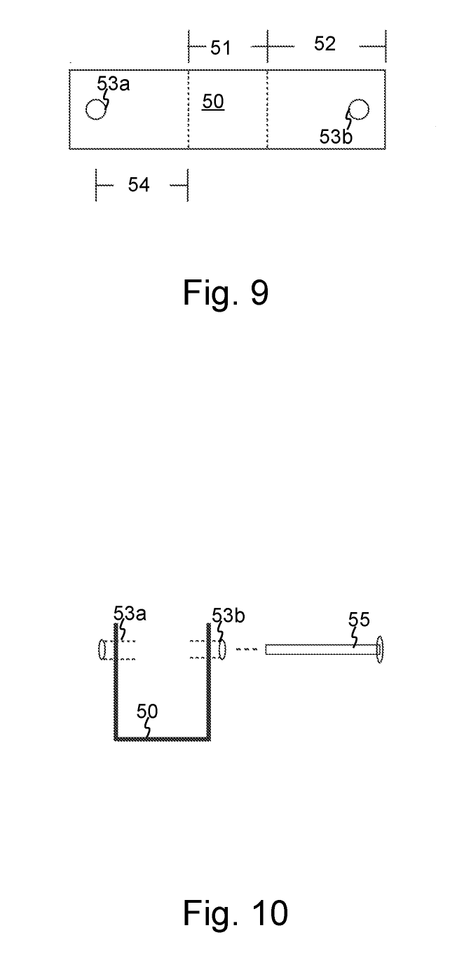

FIG. 9 is a flattened viewed of the ride-height robust sensor clamp 50. The middle section 51 of the ride-height robust sensor clamp 50 fits horizontally over the upper fork sensor clamp with side sections 52 bent parallel. Screws clamp upper fork sensor clamp tightly to ride-height robust sensor body through matched screw holes 53a and 53b. In the preferred embodiment, clamp middle section 51 is 0.9375 inches across and side sections 52 are 1.125 inches each, with the distance 54 from the center of the screw hole to corner at 0.875 inches.

FIG. 10 is a view of the ride-height robust sensor clamp 50 folded into shape. An exemplary screw 55 fits screw holes 53a and 53b. The folded ride-height robust sensor clamp 50 fits horizontally over the ride-height robust sensor body and clamp side sections 52 to hold them tightly together.

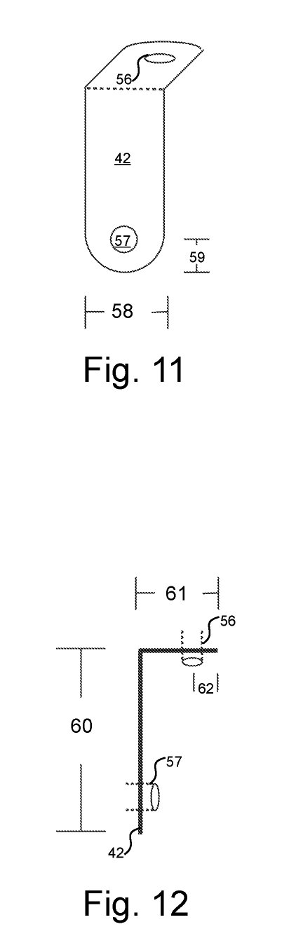

FIG. 11 is a perspective view of the ride-height lower fork bracket 42 with lower fork bracket vertical bolt hole 56 and lower fork bracket horizontal bolt hole 57. In the preferred embodiment, the ride-height lower fork bracket has a width 58 of 0.75 inches, the lower fork bracket vertical bolt hole 56 has a diameter of 0.1875 inches, lower fork bracket horizontal bolt hole 57 has a diameter of 0.250 inches and rests a distance 59 of 0.375 inches from the vertical end of the ride-height lower fork bracket 42.

FIG. 12 is a side view of the ride-height lower fork bracket 42. In the preferred embodiment, the ride-height lower fork bracket has a length 60 of 1.75 inches, a sensor limb 61 of 0.75 inches, and the vertical screw hole a distance 62 of 0.3125 inches from the sensor limb end.

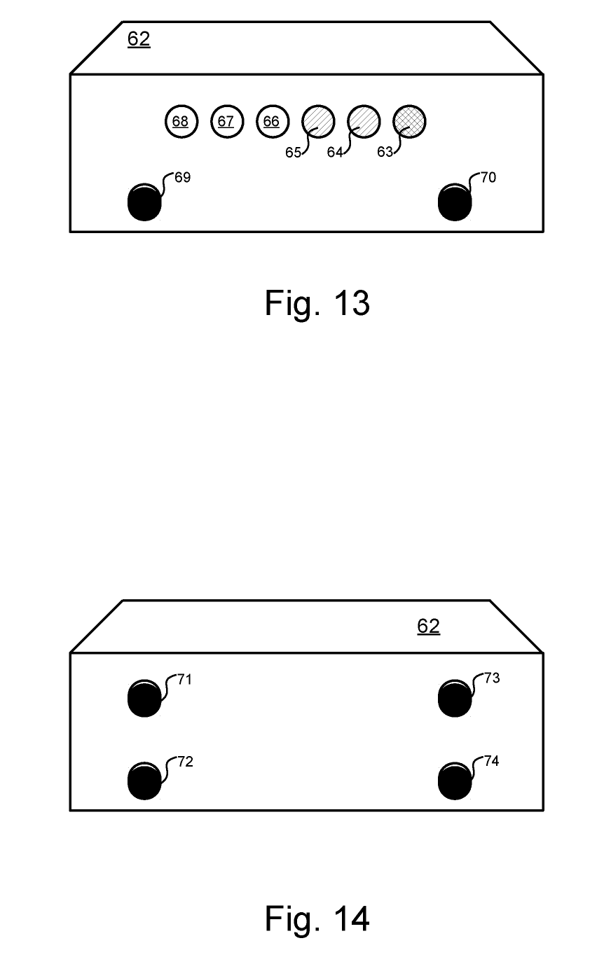

FIG. 13 depicts an exemplary front side of the ride-height display module 62. The ride-height display module 62 provides the user a visual indication of the length of the motorcycle shock-absorber as measured by ride-height robust sensors. The visual indication allows for showing at least a high shock length, a low shock length and at least one shock length between the aforementioned high and low.

In the preferred embodiment, the ride-height display module 62 features a multicolor array of six LEDs for ride-height visual indication at a glance. A red LED 63 indicates the motorcycle suspension is at or near its lowest point. Adjacent, two yellow LEDs 64 and 65 indicate suspension heights one and two steps higher than the lowest point. Adjacent the yellow LEDs, three green LEDs 66, 67 and 68 indicate progressively stepped higher suspension heights, with the final green LED indicating the suspension at or near its highest point steps. In the preferred embodiment, the red LED 63 indicates what is considered a 0% shock height, the last green LED 68 indicates what is considered 100% of the shock's greatest length and with the intermediate LED indicators corresponding to 20% increases in measured shock length.

The ride-height display module 62 also features an air down button 69 and an air up button 70. Holding the air down button 69 tells the motorcycle absolute ride-height controller to lower the suspension and holding the air up button 70 tells the motorcycle absolute ride-height controller to elevate the suspension.

In the preferred embodiment of the invention, the motorcycle absolute ride-height controller performs an Auto Dump action and an Auto Air-Up action. Auto Dump controls the shocks to release pressure, lowering the suspension to a user-set dismount height upon deactivation of the motorcycle engine. Auto Air-Up controls the shocks to return to a user-set suspension riding height upon engine start. In such embodiments, the ride-height display module 62 also features a toggle switch for disabling the Auto Dump and Auto Air-Up feature.

Users of the invention can set a custom dismount height for Auto Dump and a custom ride-height for Auto Air-Up using a combination of the disable switch and appropriate Auto Dump button 69 or Auto Air-Up button 70. In most embodiments, the dismounting height will default to completely emptying the shock absorber and dropping the suspension to its lowest level.

FIG. 14 depicts an exemplary back side of the ride-height display module 62. Included are a front high shock setting button 71, front low shock setting button 72, rear high shock setting button 73 and rear low shock setting button 74. On installing the motorcycle absolute ride-height controller, the rear shock is aired up to the maximum functional height allowed by the frame and pressing the rear high shock set button 73 correlates that height to the highest indicator on the display module. The rear shock is also deflated completely and pressing the rear low shock set button 74 correlates that height to the lowest indicator on the display module 62. The same process is performed for the front shock measurement using the front high shock setting button 71 and front low shock setting button 72.

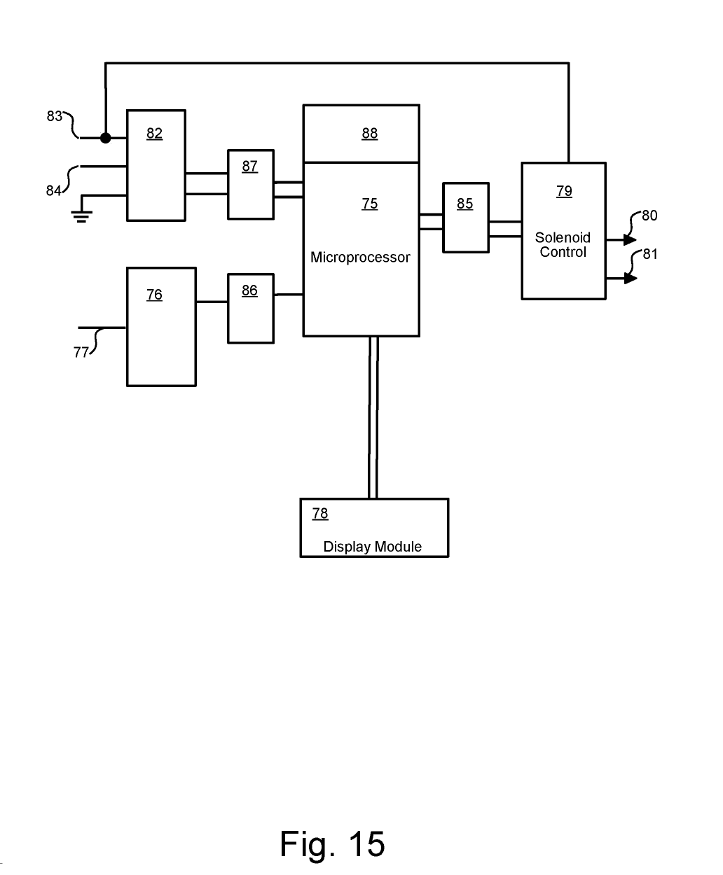

FIG. 15 is a simplified flowchart showing connections between components of the motorcycle absolute ride-height control circuit in the preferred embodiment of the invention. In the preferred embodiment, the motorcycle absolute ride-height control circuit is contained in a housing separate from the ride-height display module and is installable on or near the motorcycle battery or other motorcycle power components. However, alternate embodiments may prefer to combine elements of the control circuit and display module.

A microprocessor 75 receives ride-height sensor signals via sensor input circuitry 76 and outputs ride-height display signals to the ride-height display module 78. A ride-height robust sensor signal line 77 connects each ride-height robust sensor to input circuitry 76. In the preferred embodiment, the microprocessor 75 has a clock rate of 20 Mhz and a sleep mode with reduced current draw when the motorcycle ignition is off. User-customized Auto-Air Up settings, Auto Dump settings and other data are stored in a memory 88, either on-board to the microprocessor or separate.

Shock motor output circuitry 79 for controlling front and rear solenoids to raise and lower the front and rear motorcycle shock-absorbers is controlled by the microprocessor 75. Solenoid output circuitry 79 sends its output to the solenoid, or linear actuator, commutator or other shock-absorber motor via a shock motor control up connector 80 and a shock motor control down connector 81. In the preferred embodiment, solenoid output circuitry 79 comprises a 4 amp capable MOSFET arrangement.

A power supply module 82 provides power to the microprocessor 75 and other electronic components. The power supply module 82 draws power over a motorcycle battery input 83 and an ignition input 84. Ignition input 84 allows for automatic raising of shocks to ride-height at ignition start and automatic lowering of shocks to dismount height at ignition cutoff. Battery power also bypasses the power supply module 82 directly to the solenoid output circuitry 79.

Because motorcycle shock-raising solenoids or motors produce intermittent noise and voltage spikes which can interfere with sensor readings, a first isolation circuit 85 is used to allow one-way control signals from the microprocessor 75 to the solenoid output circuitry 79. In the preferred embodiment, the first isolation circuit 85 comprises an optocoupler with a 60 mA output. In some embodiments, a second isolation circuit 86 may be used between the ride-height robust sensor and the microprocessor. And, in some embodiments, a third isolation circuit 87 may be used between the power supply module 85 and microprocessor 75. The third isolation circuit 87 prevents interference from noisy motorcycle ignitions and provides enough current to power the microprocessor.

Although the simplified flowchart showing connections between components of the motorcycle absolute ride-height control circuit in the preferred embodiment of the invention depicts one instance of each circuit component, some embodiments of the invention use two instances of control circuit components where appropriate. For instance, embodiments of the invention implementing front and rear shock absorber control may employ two sensor input circuits and two solenoid output circuits. Some embodiments may employ two microprocessors.

Where a connection component is recited in the description of FIG. 15, this is to be understood as encompassing any integrated cable, separable cable, or cable port. Further, where any such cord, integrated cable, separable cable or cable port is recited in the description of the invention, it is to be understood as a connection component for the sake of the claims.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A motorcycle ride-height control system, comprising:
a first ride-height robust sensor capable of producing shock length measurements of a moving motorcycle;
a ride-height upper mount, said ride-height robust sensor being mountable using said ride-height upper mount to an upper portion of a motor-controlled motorcycle rear shock absorber having a variable length;
a ride-height lower mount, said ride-height robust sensor being mountable using said ride-height lower mount to a lower portion of a motor-controlled motorcycle rear shock absorber having a variable length;
a motorcycle absolute ride-height control circuit module comprising:
a microprocessor;
a memory;
an ignition power connection component;
a battery power connection component;
a ground connection component;
a first ride-height robust sensor connection component;
a first rear shock motor control circuit;
a rear shock motor control up connection component; and,
a rear shock motor control down connection component; and,
a ride-height display module comprising:
an air up control;
an air down control;
a first display indicator which indicates in response a low measurement from the first ride-height robust sensor during operation of a moving motorcycle; and,
a second display indicator which indicates in response to a high measurement from the first ride-height robust sensor during operation of a moving motorcycle.

2. The motorcycle ride-height control system of claim 1,
wherein said motorcycle ride-height control system is installable onto a motorcycle having a motor-controlled motorcycle rear shock absorber with a variable length and a starting system, and
wherein said motorcycle ride-height control system stores an automatic ride-height corresponding to a length of said motorcycle rear shock absorber,
and wherein said motorcycle ride-height control system begins to set said motor-controlled motorcycle rear shock absorber to a length corresponding to said automatic ride-height upon activation of said starting system.

3. The motorcycle ride-height control system of claim 1,
wherein said motorcycle ride-height control system is installable onto a motorcycle having a drive motor capable of being shut down and a motor-controlled motorcycle rear shock absorber having a variable length,
wherein said motorcycle ride-height control system stores an automatic dismount height corresponding to a length of said motorcycle rear shock absorber,
and wherein said motorcycle ride-height control system sets said motor-controlled motorcycle rear shock absorber to a length corresponding to said automatic dismount height upon shut down of said drive motor.

4. The motorcycle ride-height control system of claim 1, further comprising:
an auto dismount disable switch having an engage setting and a disengage setting;
wherein said motorcycle ride-height control system is installable onto a motorcycle having a drive motor capable of being shut down and a motor-controlled motorcycle rear shock absorber having a variable length,
wherein said motorcycle ride-height control system stores an automatic dismount height corresponding to a length of said motorcycle rear shock absorber,
wherein said motorcycle ride-height control system performs an Auto Dump action by setting said motor-controlled motorcycle rear shock absorber to a length corresponding to said automatic dismount height upon shut down of said drive motor, and
wherein a setting of said auto dismount disable switch prevents said Auto Dump action.

5. The motorcycle ride-height control system of claim 1, further comprising:
means for setting an Auto Air-Up suspension height.

6. The motorcycle ride-height control system of claim 1, further comprising:
a high shock setting user input control and a low shock setting user input control.

7. The motorcycle ride-height control system of claim 1, said ride-height control circuit module further comprising a first isolation circuit situated between said microprocessor and said first rear shock motor control circuit.

8. The motorcycle ride-height control system of claim 1, said ride-height control circuit module further comprising:
a first isolation circuit situated between said microprocessor and said first rear shock motor control circuit; and,
a second isolation circuit situated between a motorcycle ignition and said microprocessor.

9. The motorcycle ride-height control system of claim 1,
said motorcycle ride-height control system being installable onto a motorcycle having a motor-controlled motorcycle rear shock absorber having a variable length,
said ride-height display module comprising:
a low shock signal storing control that causes the memory store a low shock signal as measured by a ride-height robust sensor;
a high shock signal storing control that causes the memory store a high shock signal as measured by a ride-height robust sensor;
a first display indicator which indicates in response to said low shock measurement signal;
a second display indicator which indicates in response to said high shock measurement signal; and,
at least a third display indicator which indicates in response to a mid shock measurement signal;
wherein said low shock measurement signal corresponds to a shortest length of the motorcycle rear shock absorber at which said motorcycle is operable;
wherein said high shock measurement signal corresponds to a greatest length of the motorcycle rear shock absorber at which said motorcycle is operable;
wherein said above-referenced greatest length of the motorcycle rear shock absorber is greater than said above-referenced shortest length of the motorcycle rear shock absorber; and,
wherein said mid shock measurement signal corresponds to a length of the motorcycle rear shock absorber greater than said above-referenced shortest length of the motorcycle rear shock absorber and less than said above-referenced greatest length of the motorcycle rear shock absorber.

10. The motorcycle ride-height control system of claim 1, further comprising:
a second ride-height robust sensor;
an upper front fork bracket comprising:
a left front-fork slot;
a right front-fork slot; and,
a ride-height robust sensor slot;
said second ride-height robust sensor being mountable using said upper front fork bracket to an upper portion of a motor-controlled motorcycle front shock absorber having a variable length; and,
a lower front fork bracket, said second ride-height robust sensor being mountable using said lower front fork bracket to a lower portion of a motor-controlled motorcycle front shock absorber having a variable length;
said motorcycle absolute ride-height control circuit module further comprising:
a second ride-height robust sensor connection component;
a front shock motor control up connection component;
a front shock motor control down connection component; and,
a front shock motor control circuit.

11. A motorcycle ride-height control system, comprising:
a first ride-height robust sensor;
a ride-height control circuit module comprising:
a microprocessor;
a memory;
a power connection component;
a ground connection component;
a first ride-height robust sensor connection component;
a ride-height display module;
a ride-height upper mount, said ride-height robust sensor being mountable using said ride-height Upper Mount to an upper portion of a motor-controlled motorcycle rear shock absorber having a variable length; and,
a ride-height lower mount, said ride-height robust sensor being mountable using said ride-height lower mount to a lower portion of a motor-controlled motorcycle rear shock absorber having a variable length.

12. The motorcycle ride-height control system of claim 11, further comprising:
a high shock setting input and a low shock setting input.

13. The motorcycle ride-height control system of claim 11, said ride-height display module comprising:
a first display indicator that indicates in response a low shock setting signal from the ride-height robust sensor; and,
a second display indicator that indicates in response to a high shock setting signal from the ride-height robust sensor.

14. The motorcycle ride-height control system of claim 11,
said motorcycle ride-height control system being installable onto a motorcycle having a motor-controlled motorcycle rear shock absorber having a variable length,
said ride-height display module comprising:
a low shock signal storing control that causes the memory store a low shock signal as measured by a ride-height robust sensor;
a high shock signal storing control that causes the memory store a high shock signal as measured by a ride-height robust sensor;
a first display indicator which indicates in response to said low shock measurement signal;
a second display indicator which indicates in response to said high shock measurement signal; and,
at least a third display indicator which indicates in response to a mid shock measurement signal;
wherein said low shock measurement signal corresponds to a shortest length of the motorcycle rear shock absorber at which said motorcycle is operable;
wherein said high shock measurement signal corresponds to a greatest length of the motorcycle rear shock absorber at which said motorcycle is operable;
wherein said above-referenced greatest length of the motorcycle rear shock absorber is greater than said above-referenced shortest length of the motorcycle rear shock absorber; and,
wherein said mid shock measurement signal corresponds to a length of the motorcycle rear shock absorber greater than said above-referenced shortest length of the motorcycle rear shock absorber and less than said above-referenced greatest length of the motorcycle rear shock absorber.

15. A method of monitoring motorcycle suspension height, comprising:
measuring a motorcycle maximum suspension height using a ride-height robust sensor mounted to a solenoid-actuated shock absorber of a motorcycle, said shock absorber having a length and said motorcycle having a suspension height;
sending a maximum suspension height robust sensor signal corresponding to said motorcycle maximum suspension height to a microprocessor;
storing a maximum suspension height setting corresponding to said maximum suspension height robust sensor signal in a memory;
measuring a motorcycle minimum suspension height using said ride-height robust sensor mounted to said shock absorber of a motorcycle;
sending a minimum suspension height robust sensor signal corresponding to said motorcycle minimum suspension height to said microprocessor;
storing a maximum suspension height setting corresponding to said maximum suspension height robust sensor signal in a memory;
activating a maximum suspension height visual indicator in response to detecting a maximum suspension height robust sensor signal; and,
activating a minimum suspension height visual indicator in response to detecting a minimum suspension height robust sensor signal.

16. The method of claim 15, further comprising:
measuring a motorcycle medium ride-height using said ride-height robust sensor mounted to said shock absorber of a motorcycle, said medium ride-height being lower than said maximum suspension height and higher than said minimum suspension height;
sending to said microprocessor a motorcycle medium ride-height robust sensor signal corresponding to said motorcycle medium ride height; and
activating a medium ride-height visual indicator in response to detecting said medium ride-height robust sensor signal.

17. The method of claim 15, further comprising:
measuring a motorcycle custom ride-height using said ride-height robust sensor mounted to said shock absorber of a motorcycle, said motorcycle custom ride-height being higher than said minimum suspension height;
sending to said microprocessor a custom ride-height robust sensor signal corresponding to said motorcycle custom ride height;
storing in said memory a custom ride-height setting corresponding to said custom ride-height robust sensor signal;
recognizing in said microprocessor a motorcycle engine start; and,
controlling a solenoid of said shock absorber such that the shock absorber length is increased until the motorcycle suspension height is equal to said motorcycle custom ride height.

18. The method of claim 15, further comprising:
measuring a motorcycle custom ride-height using said ride-height robust sensor mounted to said shock absorber of a motorcycle, said motorcycle custom ride-height being higher than said minimum suspension height;
sending a custom ride-height robust sensor signal corresponding to said motorcycle custom ride height from said ride-height robust to said microprocessor via a one-directional isolation circuit;
storing in said memory a custom ride-height setting corresponding to said custom ride-height robust sensor signal;
receiving, in a power supply module, power from a motorcycle ignition and sending a motorcycle ignition signal from said power supply module to said microprocessor via a one-directional isolation circuit; and,
sending, in response to said motorcycle ignition signal, a solenoid control signal from said microprocessor to a solenoid control circuit via a one-directional isolation circuit; and,
controlling a solenoid of said shock absorber such that the shock absorber length is increased until the motorcycle suspension height is equal to said motorcycle custom ride height.

19. The method of claim 15, further comprising:
recognizing in said microprocessor a motorcycle engine shut-off; and,
controlling a solenoid of said shock absorber such that the shock absorber length is increased until the motorcycle suspension height is equal to said motorcycle minimum suspension height.

20. The method of claim 15, further comprising:
generating an air up control signal in response to an air up manual control activation;
controlling a solenoid of said shock absorber such that the shock absorber length is increased in response to said detecting of an air up control signal;
generating an air down control signal in response to an air down manual control activation; and,
controlling a solenoid of said shock absorber such that the shock absorber length is decreased in response to said detecting of an air down control signal.
